(19) United States
(12) Patent Application Publication
(10) Pub. No.: US 2003/0053602 A1
(43) Pub. Date: Mar. 20, 2003

(54) Subscriber-based emergency alert method and system

(76) Inventors: Bruce Edward Stuckman, Austin, TX (US); Walter Martin Malinowski, Naperville, IL (US)

Correspondence Address: BRINKS HOFER GILSON & LIONE, P.O. BOX 10395, CHICAGO, IL, 60611, US

(21) Appl. No.: 09/956,598

(22) Filed: Sep. 18, 2001

(51) Int. Cl. H04M 11/04

(52) U.S. Cl. 379/37; 379/45

(57) ABSTRACT

A method of providing an emergency alert service using a telephone network comprises transmitting, to a subscriber of the emergency alert service, an emergency message within a name parameter of a caller-identification message. As an alternative to or in addition to the aforementioned act, the method may comprise transmitting, to a subscriber, an emergency message within a name parameter of a caller-identification-with-call-waiting message. As an alternative to or in addition to the aforementioned acts, the method may comprise transmitting, to a subscriber, an emergency message within a talking-call-waiting message.

### TECHNICAL FIELD

The present invention relates to methods and systems for notifying individuals of emergency conditions.

### BACKGROUND OF THE INVENTION

Telephone-based systems for notifying users of emergency events have been proposed. A common theme of many of these systems is that calls are placed to all telephones in an area when, for instance, a tornado warning is issued by the National Weather Service.

While these services seek to provide enhanced notice to users, they are difficult to implement based on problems associated with either: (a) ringing users' telephones absent a call; (b) processing calls to all users in an area within a short time period; and (c) terminating other calling during a notice period.

In contrast to placing calls to all telephones, Qwest has an Emergency Preparedness Network (EPN) service for identifying and notifying a designated population of an impending emergency or event. Telephone numbers for a geographical area defined by an emergency event are extracted from a strictly-controlled, telephone number/address/XY-coordinate database. Outbound calls are placed to the telephone numbers, and a voice message indicating the emergency is provided.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 is a schematic, block diagram of an embodiment of a system for providing the emergency alert service; and

FIG. 2 which shows a flow chart of an embodiment of a method of providing the emergency alert service.

### DETAILED DESCRIPTION OF PREFERRED EMBODIMENTS

Disclosed herein are methods and systems for providing a subscriber-based emergency alert system. Each subscriber affected by an emergency condition is notified, at least in part, by transmitting an emergency message contained within either a name parameter of a caller-identification message, a name parameter of a caller-identification-with-call-waiting (CIDCW) message, or a talking-call-waiting message.

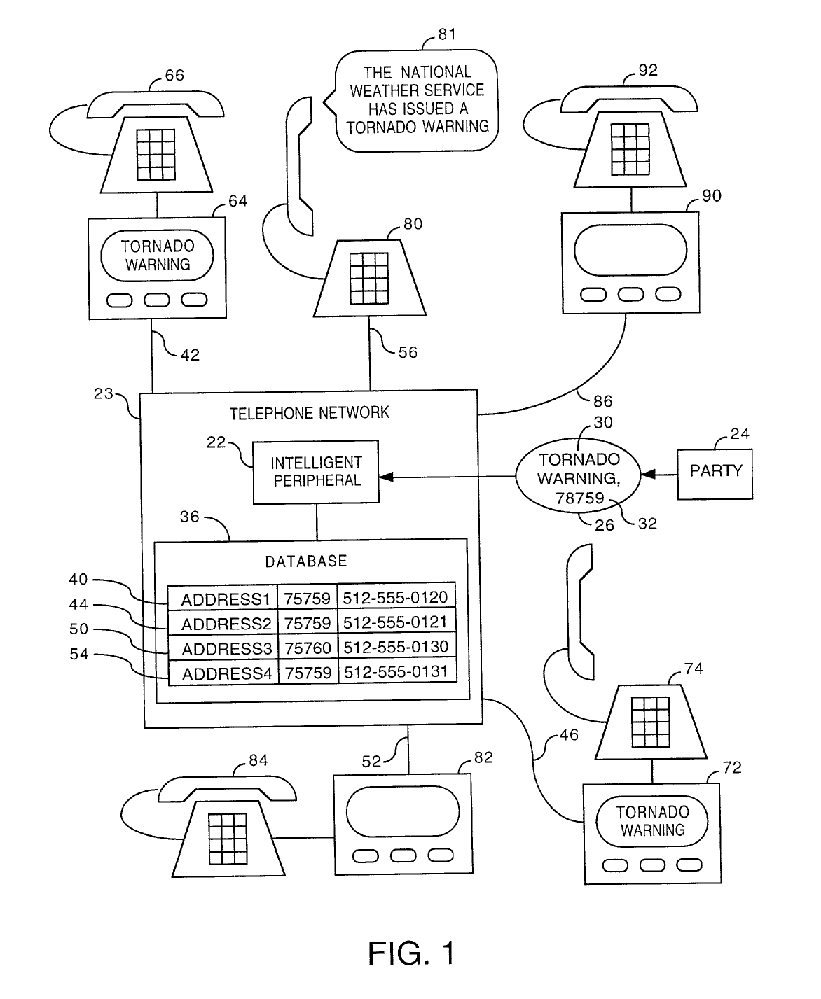

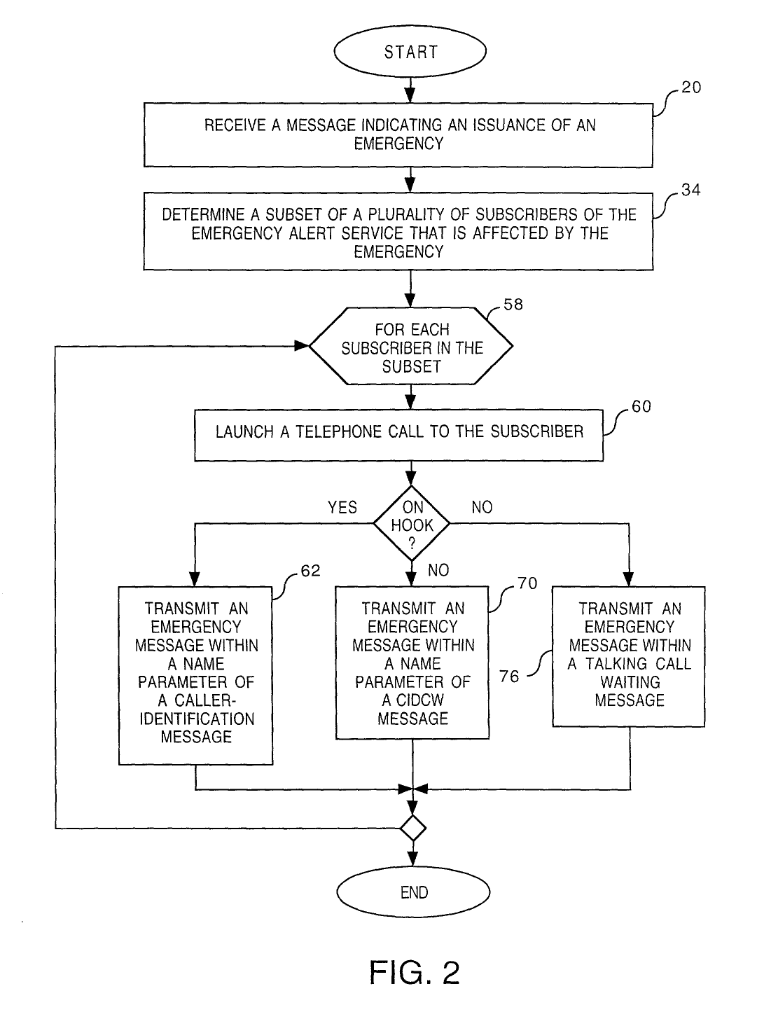

A description of embodiments of the emergency alert service is made with reference to both FIG. 1, which shows a schematic, block diagram of an embodiment of a system for providing the service, and FIG. 2 which shows a flow chart of an embodiment of a method of providing the service. Based upon the herein-disclosed high-level description, one or more computer programs to direct one or more telephone network elements to cooperate in providing the service logic are within the skill of a routineer in the art of telecommunications.

As indicated by block 20, the method comprises receiving a message indicating an issuance of an emergency. In one embodiment, the message is received by an advanced intelligent network (AIN) intelligent peripheral 22, such as a compact service node, within a telephone network 23 such as a public switched telephone network (PSTN). In alternative embodiments, other AIN components such as a service control point (SCP) or other service node or call processing platform may provide the functionality of receiving the message and initiating the service as described herein. The message can be generated by a party 24 authorized to issue the emergency and/or to alert the public of the emergency. The party 24 may use a telephone, a computer, or another communication device to compose and transmit the message.

The message indicates an emergency type and a geographical extent. Examples of emergency types include, but are not limited to, weather watches and warnings, civil defense alerts, and hazardous material accidents. The geographical extent may be defined by political boundaries such as states, counties, cities, villages and townships. Alternatively, the geographical extent may be defined by postal codes such as ZIP codes or ZIP+4 codes, or telephone codes such as telephone numbering plan area (NPA) and/or NPA-NXX. As another alternative, the geographical extent may be defined by geographical boundaries based on, for example, latitude/longitude, roads, street addresses, landmarks and/or a radius therefrom. More particularly, examples of a geographical extent include, but are not limited to:

Dallas, Tex.;

Travis County, Texas;

78759-1159 ZIP code;

a five-mile radius around 800 Green Valley Circle, Louisville, Ky.;

a ten-mile radius about 60 degrees north latitude, 30 degrees west longitude;

an area bounded by 60 and 61 degrees north latitude, and 30 and 31 degrees west longitude;

all subscribers within the 636 area code; and

all subscribers within the 636 area code and 415 exchange.

The message may directly encode emergency type data and geographical extent data. Alternatively, the message may comprise a message code which indicates a specific emergency type/geographical extent combination.

For purposes of illustration and example, consider that the emergency is a tornado warning for a county which includes a geographical area defined by the ZIP code 75759. The party 24 sends a message 26 having emergency type data 30 which encodes “TORNADO WARNING” and geographical extent data 32 which encodes “75759”. The party 24 may be authorized by the National Weather Service to send the message 26.

As indicated by block 34, the method comprises determining a subset of a plurality of subscribers of the emergency alert service that is affected by the emergency. As users subscribe to the service, information is collected on their geographical location, including their address and ZIP code. The information is placed on a database 36 associated with the intelligent peripheral 22.

For purposes of illustration and example, consider the database 36 storing information for four subscribers of the emergency alert service. The database 36 stores four data structures: a data structure 40 having an address, a ZIP code and a telephone number of a telephone line 42 of a first subscriber; a data structure 44 having an address, a ZIP code and a telephone number of a telephone line 46 of a second subscriber; a data structure 50 having an address, a ZIP code and a telephone number of a telephone line 52 of a third subscriber; and a data structure 54 having an address, a ZIP code and a telephone number of a telephone line 56 of a fourth subscriber. In this example, the subset of the subscribers that is affected by the tornado warning comprises those having a “75759” ZIP code, namely the first subscriber, the second subscriber and the fourth subscriber.

As indicated by blocks 58 and 60, the intelligent peripheral 22 sequentially launches telephone calls to all subscribers in the database whose geographical information matches the geographical extent of the emergency. A brief emergency message is transmitted to each subscriber, and the intelligent peripheral 22 moves on to call other subscribers in the subset. The method of transmitting the emergency message to a subscriber is dependent on whether the subscriber's telephone line is on-hook or off-hook.

If the subscriber's line is on-hook, an act of transmitting the emergency message within a name parameter of a caller-identification message is performed (block 62). Thus, in contrast to a typical caller-identification message in which the name parameter includes alphanumeric text of a name of a calling party, the caller-identification message of the present disclosure comprises alphanumeric text which describes the emergency. Preferably, the name parameter text is absent of any text which identifies the calling party, and does not include “out-of-area”, “unavailable”, “anonymous” or “private”.

The caller-identification message is sent during a silent interval between rings. The caller-identification message may have a standard format such as the multiple data message format (MDMF).

Returning to the example, the first subscriber has a caller identification device 64 and a telephone 66 coupled to the telephone line 42. As schematically shown in FIG. 1, the telephone 66 is on-hook at the time that the intelligent peripheral 22 places a telephone call to the telephone line 42. Preferably but optionally, the telephone call causes the telephone 66 to emit a distinctive ring to indicate the presence of an emergency message rather than a typical telephone call.

Between two rings, the intelligent peripheral 22 transmits a caller-identification message to the telephone line 42. The caller-identification message has a name parameter which includes the text “TORNADO WARNING”. The caller identification device 64 receives the message and displays the text “TORNADO WARNING”. The caller-identification message may further comprise date data, such as month data and day-of-week data, which are displayed by the caller identification device 64. Still further, the caller-identification message may comprise time data, such as hour data and minutes data, which are displayed by the caller identification device 64. In addition, the caller identification message may include the temporal extent of the emergency, e.g. “TORNADO WARNING UNTIL 7:00PM”. After transmitting the message, the intelligent peripheral 22 terminates the call, and moves on to the next subscriber in the subset if at least one subscriber remains to be notified.

If the subscriber's line is off-hook due to an in-progress call, an act of transmitting the emergency message within a name parameter of a caller-identification-on-call-waiting (CIDCW) message may be performed (block 70). Thus, in contrast to a typical CIDCW message in which the name parameter includes alphanumeric text of a name of a calling party, the CIDCW message of the present disclosure comprises alphanumeric text which describes the emergency. Preferably, the name parameter text is absent of any text which identifies the calling party, and does not include “out-of-area”, “unavailable”, “anonymous” or “private”.

Returning to the example, the second subscriber has a caller identification device 72 and a telephone 74 coupled to the telephone line 46. As schematically shown in FIG. 1, the telephone 74 is off-hook at the time that the intelligent peripheral 22 is to transmit the emergency message via the telephone line 46. The intelligent peripheral 22 sends an alerting signal to the telephone line 46. The caller identification device 72 receives the alerting signal, and responds by sending an acknowledgment signal back to the intelligent peripheral 22. In response to receiving the acknowledgment signal, the intelligent peripheral 22 transmits a CIDCW message to the telephone line 46. The CIDCW message has a name parameter which includes the text “TORNADO WARNING UNTIL 7:00PM”. The CIDCW message may have a standard format such as MDMF. The caller identification device 72 receives the message and displays the text “TORNADO WARNING UNTIL 7:00PM”. The CIDCW message may further comprise date data, such as month data and day-of-week data, which are displayed by the caller identification device 64. Still further, the CIDCW message may comprise time data, such as hour data and minutes data, which are displayed by the caller identification device 64. After transmitting the message, the intelligent peripheral 22 moves on to the next subscriber in the subset if at least one subscriber remains to be notified.

As an alternative to transmitting a CIDCW message if the subscriber's line is off-hook due to an in-progress call, an act of transmitting the emergency message within a talking-call-waiting message may be performed (block 76). Thus, in contrast to a typical talking-call-waiting message which comprises an audible name of a calling party, the talking-call-waiting message of the present disclosure comprises an audible description of the emergency. In a preferred embodiment, the talking-call-waiting message is implemented in accordance with the methods and systems described in such references as U.S. Pat. Nos. 4,899,358, 5,007,076 or 6,219,414, the disclosures of which are incorporated herein by reference thereto.

Returning to the example, the fourth subscriber has a telephone 80 coupled to the telephone line 56. As schematically shown in FIG. 1, the telephone 80 is off-hook at the time that the intelligent peripheral 22 is to transmit the emergency message via the telephone line 56. For example, the fourth subscriber may have an in-progress telephone call with the second subscriber at this time.

The intelligent peripheral 22 transmits a talking-call-waiting message to the telephone line 56 during the in-progress telephone call. The talking-call-waiting message includes either a prerecorded or voice-synthesized audible message 81 such as “The National Weather Service has issued a Tornado Warning for your area until 7:00PM this evening”. The telephone 80 receives the message and audibly outputs the emergency message. After transmitting the message, the intelligent peripheral 22 moves on to the next subscriber in the subset if at least one subscriber remains to be notified.

Since all three of the subscribers having the matching geographical extent data are notified, no further emergency messages are transmitted. Thus, the service does not send the emergency message to the third subscriber having a caller identification device 82 and the telephone 84 coupled to the telephone line 52, since his/her ZIP code is 75760. Further, an emergency message is not sent to a service non-subscriber having a telephone line 86 in the ZIP code 75759 affected by the tornado warning. Thus, the emergency message is neither visually displayed by a caller identification device 90 nor audibly outputted by a telephone 92.

Once the emergency either has expired or has been terminated, the party 24 may send an “all-clear” message or the like, along with the “78759” ZIP code to the intelligent peripheral 22. In response thereto, the intelligent peripheral 22 sends the all-clear message to the first subscriber, the second subscriber and the fourth subscriber. It is noted that a subscriber may receive the tornado warning message and the all-clear message in different forms. For example, the first subscriber, who received the tornado warning message within a caller-identification message, may receive the all-clear message as a talking call waiting message if he/she has an in-progress telephone call at the time of the all-clear condition. In an alternative embodiment, where the temporal extent of the emergency was transmitted in conjunction with the emergency alert, an all-clear message may optionally not be transmitted.

It is noted that some acts illustrated in FIG. 2 may be performed concurrently. For example, one or more telephone calls may be launched in block 60 before all of the subset of subscribers has been determined in block 34. Further, multiple telephone calls may be placed concurrently, and multiple emergency messages may be transmitted concurrently.

Preferred embodiments of a subscriber-based emergency alert method and system have been described herein. By providing the emergency message within a name parameter of either a caller-identification message or a CIDCW message, the emergency message may be provided to a subscriber without having to ring his/her telephone more than once or twice. This saves time in contrast to waiting for the subscriber to answer the telephone call and to listen to an audible message. The herein-described service may be bundled with either a call waiting service or a talking call waiting service so that subscribers who are on their telephone during a notice period would receive a call or audible notice of an emergency.

The subscriber-based nature of the service allows the service to be rolled out gradually and in such a fashion to mitigate build-out issues. After an initial roll out of the service, additional resources such as additional compact service nodes may be added based upon actual demand for the service in each region. Call saturation of central office switches can be avoided if the penetration rates of the service are capped not to exceed a saturation threshold. Customers would be allowed to subscribe to the service only if the sufficient network resources were in place to contact all subscribers for the service in their area within a predetermined minimum time.

Optionally, the service may further include a pager capability wherein the herein-described emergency message and/or all-clear message is transmitted to one or more pagers of one or more respective subscribers. The pager may be a subscriber's general purpose pager, i.e. a pager he/she uses to receive non-emergency messages. Alternatively, the pager may be dedicated to receiving emergency messages and/or all-clear messages. The dedicated pager may be provided to the subscriber by the service provider. Emergency paging messages, such as “TORNADO WARNING” or “TORNADO WARNING UNTIL 7:00PM” may be broadcast to a plurality of subscribers. Use of paging messages enables a subscriber to be alerted of an emergency condition in his/her home vicinity while he/she is remotely located from home.

It will be apparent to those skilled in the art that the disclosed invention may be modified in numerous ways and may assume many embodiments other than the preferred form specifically set out and described above. For example, one or more other types of telephone network elements may be used to perform the service logic of the intelligent peripheral 22. Acts performed by the intelligent peripheral 22 or alternative telephone network elements may be directed by computer-readable program code stored by a computer-readable medium. Further, alternative types of customer premises equipment (CPE) may be substituted for the herein-disclosed telephones and caller-identification devices.

Accordingly, it is intended by the appended claims to cover all modifications of the invention which fall within the true spirit and scope of the invention.

What is claimed is:

1. A method of providing an emergency alert service using a telephone network, the method comprising:
receiving a message indicating an issuance of an emergency;
based on the message, determining a subset of a plurality of subscribers of the emergency alert service that is affected by the emergency, the subset comprising a first subscriber, a second subscriber and a third subscriber;
transmitting, to the first subscriber, a first emergency message within a name parameter of a caller-identification message;
transmitting, to the second subscriber, a second emergency message within a name parameter of a caller-identification-on-call-waiting message while the second subscriber has an in-progress call; and
transmitting, to the third subscriber, a third emergency message within a talking-call-waiting message while the third subscriber has an in-progress call.

2. The method of claim 1 wherein the caller-identification message and the caller-identification on-call-waiting message are multiple data message format (MDMF) messages.

3. A method of providing an emergency alert service using a telephone network, the method comprising:
transmitting, to a subscriber of the emergency alert service, an emergency message within a name parameter of a caller-identification message.

4. The method of claim 3 further comprising:
transmitting, to the subscriber, an all-clear message within a name parameter of a caller-identification message.

5. The method of claim 3 further comprising:
transmitting, to the subscriber, an all-clear message within a name parameter of a caller-identification-with-call-waiting message.

6. The method of claim 3 further comprising:
transmitting, to the subscriber, an all-clear message within a talking-call-waiting message.

7. The method of claim 3 wherein the caller-identification message is a multiple data message format (MDMF) message.

8. The method of claim 3 wherein the caller-identification message is a caller-identification-on-call-waiting message, and wherein said transmitting the emergency message is performed while the subscriber has an in-progress call.

9. A method of providing an emergency alert service using a telephone network, the method comprising:
transmitting, to a subscriber of the emergency alert service, an emergency message within a talking call waiting message while the subscriber has an in-progress call.

10. The method of claim 9 further comprising:
transmitting, to the subscriber, an all-clear message within a name parameter of a caller-identification message.

11. The method of claim 9 further comprising:
transmitting, to the subscriber, an all-clear message within a name parameter of a caller-identification-with-call-waiting message.

12. The method of claim 9 further comprising:
transmitting, to the subscriber, an all-clear message within a talking-call-waiting message.

13. A system for providing an emergency alert service using a telephone network, the system comprising:
a telephone network element to transmit, to a subscriber of the emergency alert service, an emergency message within a name parameter of a caller-identification message.

14. The system of claim 13 wherein the telephone network element further is to transmit, to the subscriber, an all-clear message within a name parameter of a caller-identification message.

15. The system of claim 13 wherein the telephone network element further is to transmit, to the subscriber, an all-clear message within a name parameter of a caller-identification-with-call-waiting message.

16. The system of claim 13 wherein the telephone network element further is to transmit, to the subscriber, an all-clear message within a talking-call-waiting message.

17. The system of claim 13 wherein the caller-identification message is a multiple data message format (MDMF) message.

18. The system of claim 13 wherein the caller-identification message is a caller-identification-on-call-waiting message, and wherein the telephone network element is to transmit the emergency message while the subscriber has an in-progress call.

19. The system of claim 13 wherein the telephone network element comprises an intelligent peripheral.

20. The system of claim 13 wherein the telephone network element comprises a compact service node.

21. A system for providing an emergency alert service using a telephone network, the system comprising:
a telephone network element to transmit, to a subscriber of the emergency alert service, an emergency message within a talking call waiting message while the subscriber has an in-progress call.

22. The system of claim 21 wherein the telephone network element further is to transmit, to the subscriber, an all-clear message within a name parameter of a caller-identification message.

23. The system of claim 21 wherein the telephone network element further is to transmit, to the subscriber, an all-clear message within a name parameter of a caller-identification-with-call-waiting message.

24. The system of claim 21 wherein the telephone network element further is to transmit, to the subscriber, an all-clear message within a talking-call-waiting message.

25. The system of claim 21 wherein the telephone network element comprises an intelligent peripheral.

26. The system of claim 21 wherein the telephone network element comprises a compact service node.
